(19) United States
(12) Patent Application Publication
(10) Pub. No.: US 2025/0353159 A1
(43) Pub. Date: Nov. 20, 2025

(54) HAND TOOL

(71) Applicant: GUSTAV KLAUKE GMBH, Remscheid (DE)

(72) Inventor: Egbert FRENKEN, Heinsberg (DE)

(73) Assignee: GUSTAV KLAUKE GMBH, Remscheid (DE)

(21) Appl. No.: 18/871,298

(22) PCT Filed: Jun. 12, 2023
(86) PCT No.: PCT/EP2023/065651

§ 371 Date: Dec. 3, 2024

(30) Foreign Application Priority Data
Jun. 10, 2022 (DE) 10 2022 114 706.1
Oct. 25, 2022 (DE) 10 2022 128 187.6

(51) Int. Cl. B25F 5/00; B25B 27/14

(52) U.S. Cl. CPC B25F 5/005; B25B 27/146

(57) ABSTRACT

A hand tool includes an actuator which drives a moving part directly or via a gearbox or by a hydraulic medium for performing an intended operation. A chamber formed in the hand tool can be changed and evaluated for acquiring a state of the hand tool. The operation can be performed independently of the air pressure that develops in the chamber.

### AREA OF TECHNOLOGY

The described solution relates to a hand tool with an actuator and a moving part, wherein the actuator drives the moving part directly or via a gearbox or by a hydraulic medium for performing an intended operation, with a chamber formed in the hand tool, in which an air volume with an air pressure is or can be enclosed.

### PRIOR ART

Hand tools of the kind in question are known in a variety of designs. For example, the latter are used for pressing, cutting, punching, crimping, or, for example, solely for capturing tools, wherein work is most often performed indirectly or directly against a fixed part on the tool side via the moving part, with the workpiece to be machined being placed in between. For this purpose, the moving part is indirectly or directly moved out of a movement start position in the direction toward a movement end position via an actuator, wherein the actuator can be an electric motor that acts with the interposition of a gearbox and/or via a hydraulic medium. For example, the actuator can also be a movable hand lever, which can act directly or indirectly on the moving part, for example via a hydraulic medium.

With respect to a hand tool designed as a hydraulically acting pressing tool, reference is exemplarily made to WO 03/084719A2 (U.S. Pat. No. 7,254,982 B2), EP 1 084 798 B1 (U.S. Pat. No. 6,718,870 B2), or also to WO 2020/053101 A1 (US 2021/0339367 A1), and further exemplarily also to WO 2021/069587 A1 or to DE 10 2013 101 978 A1. For example, a hand tool designed as a pressing tool with an electric motor that acts on the moving part via a gearbox is known from DE 10 2014 100 348 A1. A pincer type hand tool is further exemplarily known from WO 2019/219407A1 (US 2021/0296837A1).

The contents the of aforementioned patent specifications and patent applications are hereby fully incorporated into the disclosure of the present solution, including for the purpose of incorporating the features disclosed in such a publication into claims of the present application.

As known from the prior art cited for the pressing devices, a return spring that loads the moving part, for example in the direction toward the movement start position, can be arranged in a chamber situated in the hand tool.

### SUMMARY OF THE SPECIFICATION

The object is to advantageously design a hand tool of the kind in question.

The solution can be given by the moving part or an operating part being independent of the moving part being configured to change the air pressure by changing a space of the chamber or instead of delivering additional air into the chamber, wherein further the air pressure can evaluated for identifying a state of the hand tool, wherein the driving of the moving part can be performed with or without making use of the pressure.

The solution is also to describe by the ability to change the air pressure and evaluate it for acquiring a state of the hand tool, wherein the operation can be performed independently of the air pressure that develops in the chamber.

During the displacement of the moving part from the movement start position in the direction toward the movement end position, but also additionally or alternatively possibly during the displacement of the moving part from the movement end position back in the direction toward the movement start position, a change in air pressure may arise in the chamber. The change in air pressure can be present independently of the displacement of the moving part, perhaps as the result of a specially actuated control unit, which can lead to the pressure increase, or of a pressure source connected By evaluating the actual air pressure, preferably as a function of at least one stored target air pressure, knowledge can be gained about the state, for example the functionality, of the hand tool. Furthermore, such comparisons with stored target values can also take place during the displacement of the hand tool in various moving part positions.

In one possible configuration, the moving part can be portion of a chamber, or at least partially limit the chamber. The change in air pressure can here be a direct function of a displacement of the moving part. Accordingly, the air pressure to be monitored can generally be acquired in the area of the displacement path of the moving part.

The acquirable and evaluable change in air pressure can also generally be caused directly by a pump that conveys a hydraulic medium for displacing the moving part. The pump can be acted upon by a gearbox, which converts a rotational movement of an electric motor into a back and forth movement. The gearbox can be a friction gearbox. A movement of the gearbox can be used for generation via air pressure. The gearbox can here simultaneously act like an air piston pump (with the hand tool operating as intended) to pump air into a sealed or sealable chamber. The air pressure prevailing in the chamber that is potentially locally provided relative to the pump and/or the drive and/or the moving part is acquired.

An evaluation of the air pressure change in the chamber can result in an adjusted display for the user. In the simplest form, this can be a pointer which becomes visible to the user during the change in air pressure. For example, an analog or digital display can further be provided, which possibly displays only two possible states, or also any change in air pressure, for example given a digital pressure value display. Other optical and/or acoustic signals can potentially also be triggered as a function of a change in air pressure.

In addition, data about the acquired changes in air pressure can also be stored in a possibly provided data memory of the hand tool, or also on an external data memory, to which the data can be transmitted, for example via radio.

The air pressure to be achieved in the chamber and acquirable in the process preferably does not contribute to the developing force that acts on the workpiece during operation of the hand tool. The operation is also performed independently of the air pressure that is potentially generated in the chamber while performing the operation. The air pressure can even tend to form a counterforce, but it is clearly subordinate to a driving force which the actuator develops for performing the operation. The pressure values that can be reached in the chamber are preferably so low as to be inadequate for initiating the pressing or cutting of a workpiece by themselves, or significantly supporting this process.

Additional features are often described below-including in the figure description—in their preferred allocation to the basically described solution or to additional features. However, they can also be significant as allocated to only individual, already described features of the basic solution or to the respective further described feature, or each independently of each other.

In a possible embodiment, a pressure sensor is provided for measuring the air pressure in the chamber. An air pressure measured by such a pressure sensor can be evaluated to acquire the state of the hand tool. Conclusions can be drawn via such a measurement evaluation, for example relating to proper operational aspects.

The pressure sensor can be directly arranged on the chamber, facing the interior of the chamber. The pressure sensor can be acted upon directly by the air pressure in the chamber. However, the pressure sensor can also be acted upon only indirectly, e.g., by an interspersed part that is moved by the air pressure or the like. The pressure sensor can also be provided spaced locally apart from the chamber, but connected with the chamber interior via an airway.

The change in air pressure can be generated by changing a size of the chamber. Such a change in chamber size can be directly related with the displacement of the moving part, in particular in those configurations where a portion of the moving part is designed as a piston that can be moved during displacement in the chamber. In particular as the moving part is being displaced from the movement start position in the direction toward the movement end position, wherein the moving part is formed as a piston and the moving part is included in the chamber, the piston section moving in the chamber produces a successive reduction in chamber size. The piston can form a-movable-part of the chamber wall.

The change in air pressure in the chamber can also be generated by changing the quantity of air enclosed in the chamber. For example, the air pressure in the chamber can be changed without necessitating any travel by the moving part by connecting a pump or a compressor to the chamber.

Furthermore, the change in air pressure can arise with the initiation or performance of the operation, accordingly while using the hand tool, thereby possibly also enabling a safety-relevant monitoring during the operation by acquiring and evaluating the air pressure that develops in the chamber. A safety-relevant part, for example a bolt, can be included in a closure of the chamber. For example, the absence of the safety-relevant part will then not lead to an otherwise expected rise in air pressure, or not to a predetermined extent.

According to a preferred embodiment, the chamber can have a pneumatic sensor in the form of a sealable opening. It is further preferred that such an opening be separate to any other openings, for example through which a portion of the moving part exits outwardly as viewed from the chamber, or also to an opening through which the moving part is acted upon inside of the chamber.

The sealable opening of the chamber can be a relevant part for acquiring the state of the hand tool. The seal can be formed by separate apparatus that are not directly required for performing the operation, or also by one or several parts or sections of the hand tool itself. The one or several parts of the hand tool itself can also be directly required for performing the operation, or necessary for safety reasons. An expected air pressure that does not develop can also be regarded as a part that is required directly for performing the operation or essential for safety reasons being absent or damaged. The user can also bring a closure of the opening while operating the hand tool.

Another embodiment can provide that the opening be connected with the chamber by an airway. This makes it possible to achieve a local separation between the chamber and opening. If the airway is included in the chamber, a chamber with a comparatively great length results in this respect. The airway can be provided by a channel incorporated into the hand tool, or also by a hose preferably laid in the hand tool.

In addition, several such openings can be provided in the hand tool, which are all connected with the chamber by airways. This makes it possible to monitor various safety-relevant areas of the hand tool by acquiring the air pressure values just in the (preferably only one) chamber.

The moving part can be a traversing part, which can be traversed from a traversing start position into a traversing end position—and vice versa. For example, such a traversing part is a traversable pressing jaw in a hand tool for compressing a pellet, wherein this traversable pressing jaw can be moved in the direction toward a fixed pressing jaw. For example, the traversing part can further also be a traversable cutting jaw, which can be moved in the direction toward a fixed cutting jaw. In this consideration, various portions of the hand tool can be considered as the moving part. In a hydraulically driven hand tool, for example, the piston can also be the moving part in terms of this disclosure.

Above and below, the moving part is also referenced as a traversing part, and a movement of the traversing part is also referred to as a traversing of the traversing part or moving part.

A defined displacement path of the traversing or moving part is preferably provided in the hand tool. In particular the traversing end position, but further for example also one or several traversing intermediate positions and/or the traversing start position can be determined and/or monitored via air pressure acquisition. For example, this acquisition further makes it possible to detect the intended completion of an operation upon reaching the traversing end position. In addition, for example, a disruption during the traversal of the traversing or moving part can further be acquired, for example via a comparison between an intended air pressure value in a specific traversing position (e.g., traversing end position) and the determined actual air pressure value.

The traversal of the traversing part can here be accompanied by a reduction of the chamber, which causes the air pressure in the chamber to rise with the chamber generally closed to the environment as the traversing part increasingly traverses out of the traversing start position.

The increase in air pressure in the chamber can further be associated with an increase in a temperature of the air volume in the chamber. Accordingly, the temperature increase can also be drawn upon for evaluating the state of the hand tool. A temperature sensor can be used to measure this increase in temperature.

The pressure increase in the chamber can be regarded as a measure for the traversing path. The measure of the air pressure in the chamber can be monitored over the entire traversing path via repeated pressure measurements. For example, a continuously rising air pressure can here be determined, or further, for example, a sudden, significant rise in pressure as well. Monitoring over the entire traversing path during a continuous measurement can be achieved by a comparison with stored target values. For example, when monitoring for a sudden and significant pressure rise, a check can be performed to see whether a specific traversing position has been reached.

The pressure increase in conjunction with an increase in temperature can also be regarded as a measure for the traversing path. For example the measured values can be drawn upon in combination—in the mathematical sense of an AND connection, in which both measurements must point to a (significant) increase—for determining a specific traversing position. Alternatively, the acquisition of just one (significant) measured value rise in the two measurements—in the mathematical sense of an OR connection of both measurements—can indicate that a specific traversing position has been reached.

The provided opening can be sealable by traversing the traversing part into a specific traversing position, preferably the traversing end position. In this way, the traversing or moving part can be set in a sealing manner in front of the opening with a section of the traversing part in this predetermined position. In a possible embodiment, the opening can be exposed in the presence of the otherwise given traversing path from the traversing start position up to the predetermined traversing position, so that generally an ambient pressure arises in the chamber over this traversing path.

As a consequence, the traversal of the traversing part makes it possible to raise the air pressure in the chamber upon reaching the traversing end position and with the accompanying closure of the opening. A jump in air pressure can be noted via the pressure sensor.

This (abrupt) increase in air pressure in the chamber is preferably regarded as the traversing end position of the traversing part having been reached.

In another embodiment, the hand tool can have a working head. For example, a working head for compressing a pellet can be involved.

The working head can thus have a tool with a pressing contour, wherein this tool can also be interchangeably held in the working head. The pressing contour formed in the tool can have an opening, which can be connected with the chamber via an airway.

This opening is usually exposed, so that the chamber interior is connected with the environment via the airway. In a preferred embodiment, the opening can here be formed in an area of the tool which cannot be reached by a pellet placed in the pressing mouth that arises between the tools, in particular in the state where it has not yet been influenced in terms of compression. The displacement of the tool and accompanying pressing effect on the pellet can cause the pellet to become deformed in such a way as to deform an outer surface of the pellet adjusted to a tool matrix, for example. During this deformation, preferably at the end of the deformation process, the pellet material is deformed in such a way that it reaches the area of the opening, and the opening is finally covered so as to be at least approximately sealed.

The pressure increase in the chamber achieved with the closure of the opening can thus be regarded as a completed compression of the pellet. A possible pulsed or sudden rise in air pressure in the chamber suggests a closure of the opening, wherein this closure can preferably be achieved solely via the complete deformation of the pellet and the accompanying adjustment to the matrix.

In another embodiment, the hand tool can have a connected or connectable accumulator for operating an electric drive. The proposed air pressure acquisition in the chamber can here be used by way of a pressure increase in the chamber to indicate the presence of a properly connected accumulator undamaged in particular on the housing side. The chamber can thus be formed completely or even just partially by a housing interior of the accumulator housing. An air pressure acquired during hand tool operation that is smaller than a prescribed target air pressure can suggest a crack in the accumulator housing, for example. In the event of such a housing crack, the chamber is not closed to the environment, so that no sufficiently increased air pressure can be built up, if any.

### BRIEF DESCRIPTION OF THE DRAWINGS

While the described solution is explained below based upon the attached drawing, the latter only depicts exemplary embodiments. Therefore, a part that is described only in relation to one of the exemplary embodiments and is not replaced by a different part in another exemplary embodiment due to the feature highlighted therein is also described as a part that can in any event be present even for this other exemplary embodiment. The drawing shows:

FIG. 1 a partially cut side view of an electric motor-driven hand tool in a first embodiment, relating to a traversing start position of a moving or traversing part;

FIG. 2 the schematically depicted section in sectional plane III of FIG. 1;

FIG. 3 the magnification of area III of FIG. 1;

FIG. 4 a view corresponding to FIG. 3, relating to a traversing end position of the traversing part;

FIG. 4a an enlarged part of FIG. 4 showing a realization of an operating part being independent of the moving part;

FIG. 5 a perspective, individual view of the traversing part;

FIG. 6 an air pressure measurement diagram;

FIG. 7 a sectional view according to FIG. 3, relating to a second embodiment;

FIG. 8 the magnification of area VIII of FIG. 7;

FIG. 9 a view corresponding to FIG. 7, relating to the traversing end position of the traversing part;

FIG. 10 the magnification of area X of FIG. 9;

FIG. 11 a sectional view according to FIG. 7, relating to a third embodiment;

FIG. 12 the magnification of area XII of FIG. 11;

FIG. 13 a view corresponding to FIG. 11, relating to the traversing end position;

FIG. 14 the magnification of area XIV of FIG. 13;

FIG. 15 a side view of a tool in another embodiment;

FIG. 16 a schematic view of a hand tool in another embodiment;

FIG. 17 a view of a hand tool in another embodiment;

FIG. 18 a schematic longitudinal sectional view of a hand tool in another embodiment;

FIG. 19 a schematic view representation of a hand tool in another embodiment, relating to a start position of a moving part;

FIG. 20 a view corresponding to FIG. 19, relating to an end position of the moving part;

FIG. 21 a partially cut view of a hand tool, relating to another embodiment;

FIG. 22 another, likewise partially cut view of the hand tool according to FIG. 21;

FIG. 23 the magnification of area XXIII of FIG. 21;

FIG. 24 the magnification of area XXIV of FIG. 22.

### DESCRIPTION OF THE EMBODIMENTS

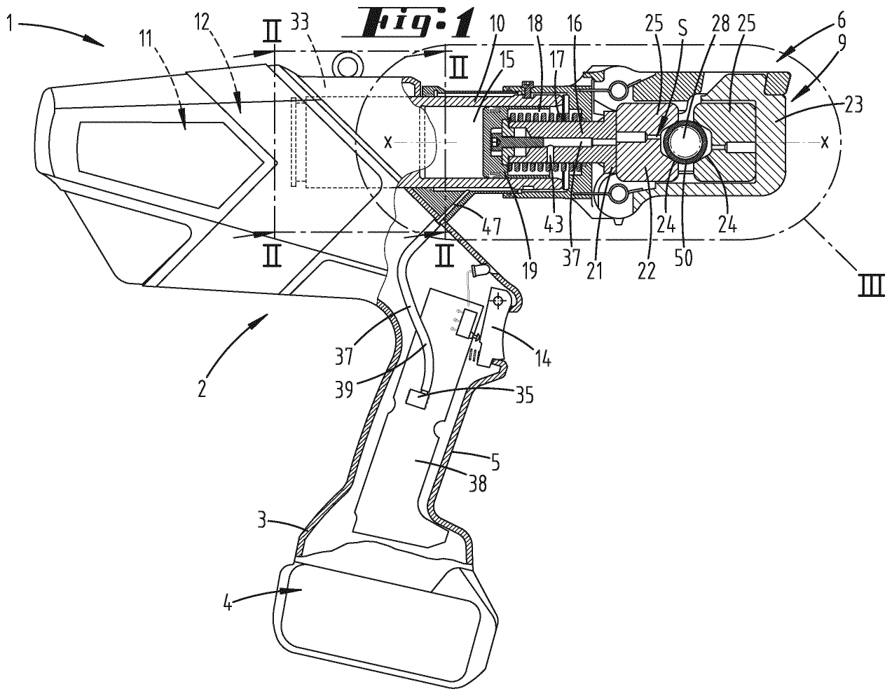

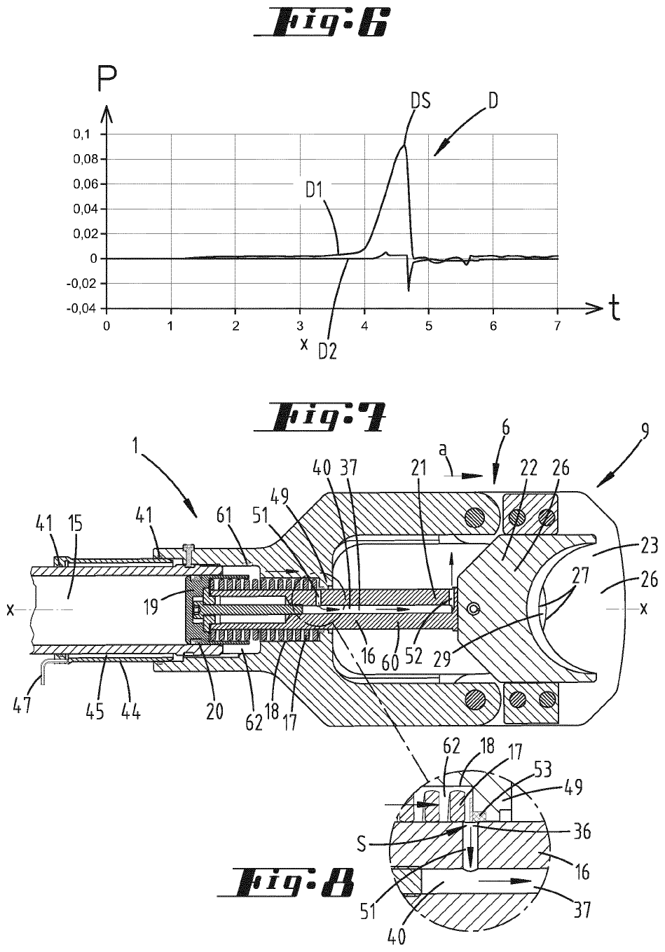

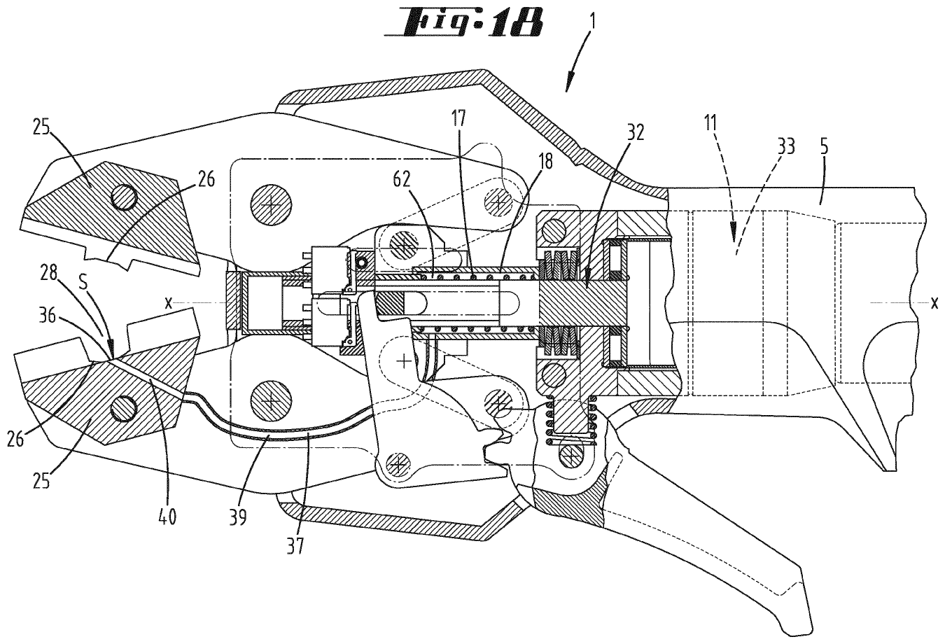

The figures described below show various embodiments of a hand tool 1, wherein FIGS. 1 to 6 relate to a first embodiment, FIGS. 7 to 10 to a second embodiment, and FIGS. 11 to 14 to a third embodiment; FIGS. 15 to 20 show additional exemplary embodiments, and FIGS. 21 to 24 another embodiment. Other alternative embodiments are also possible apart from the above, so that FIGS. 1 to 24 must here not be construed as limiting, but rather serve to explain the possible features.

The hand tool 1 shown among other places of FIG. 1 in the first embodiment can have a pistol-shaped basic tool base 2 forming a tool housing. Alternatively, the basic tool base 2 according to FIG. 15 or 21 can also be elongated and rod-shaped in design.

The hand tool 1 is here exemplarily a hydraulically actuatable pressing or crimping tool. Alternatively, however, the hand tool 1 can also be modified in such a way as to serve other purposes, for example for cutting (as exemplarily shown of FIG. 7 to 14) or punching workpieces.

The basic tool base 2 further has a handle 5 that is aligned generally transverse to a geometric longitudinal axis x of the basic tool base 2, with which a user can guide the hand tool 1. If operation is to be wireless, a power source in the form of an accumulator 4 is arranged at the free end piece 3 of the handle 5 for supplying power to the hand tool 1. Alternatively, the power source may include an electric cable that can also be used to establish a connection to a power supply via an electric network.

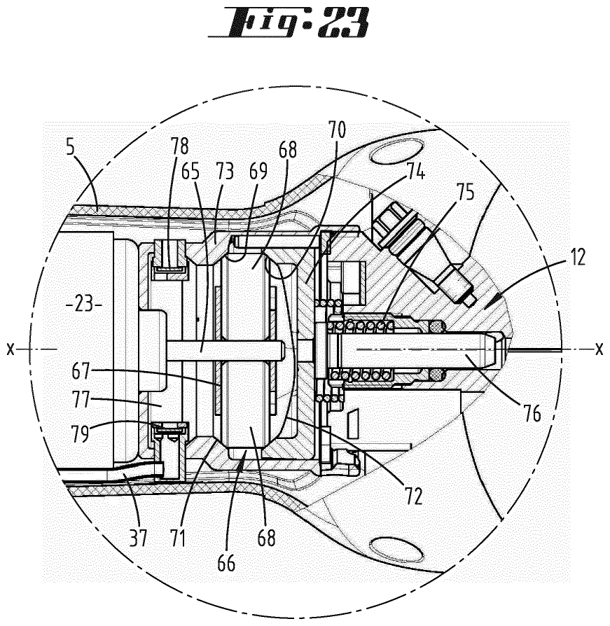

Given a rod-like configuration of the hand tool 1, the handle 5 can also be formed as an axial extension of the basic tool base 2 (for example, see FIGS. 21 and 22).

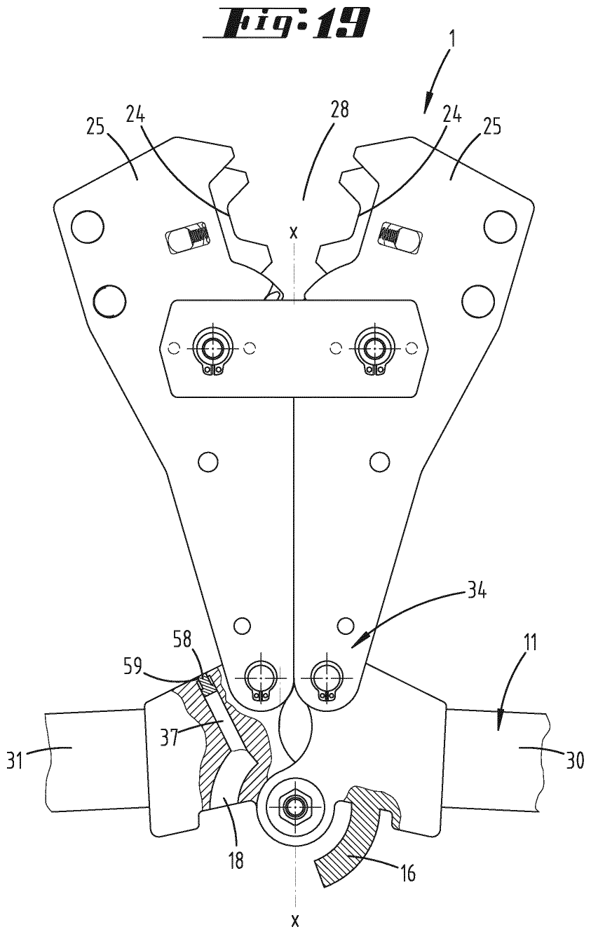

Within the framework of the solution described here, the hand tool 1 can also be designed in particular to have the power source separate from the tool 1. For example, a separately provided actuator 7, in particular a separate power supply device and/or a separately provided hydraulic pump, which is connected with a working head 9 of the hand tool 1 via a hydraulic hose 8 (see FIG. 16).

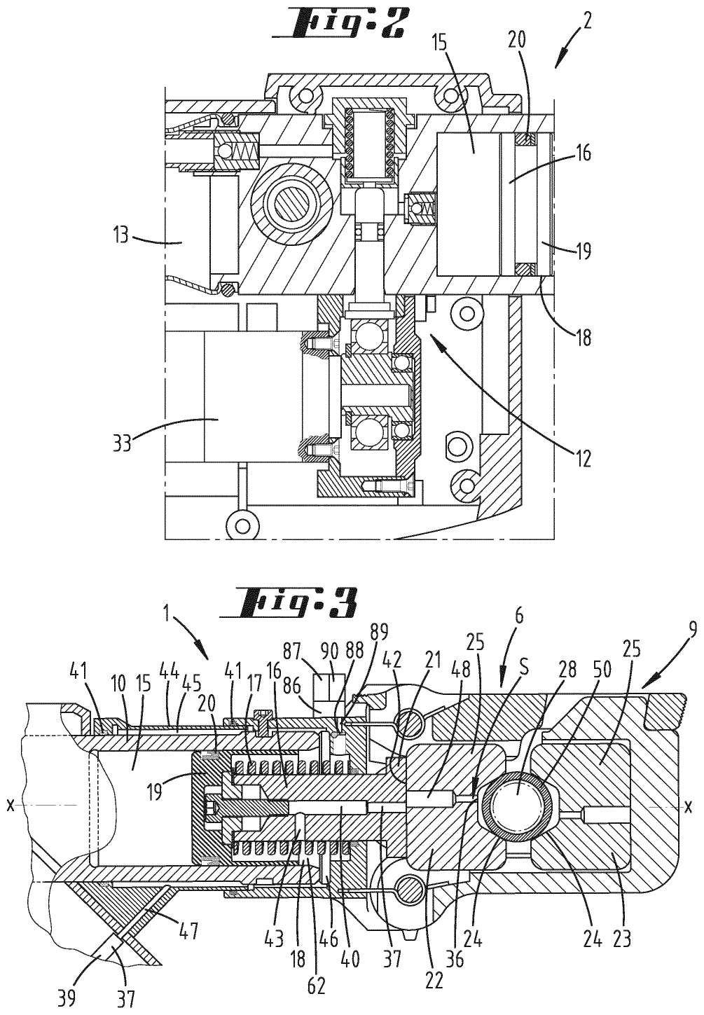

In the embodiments depicted according to FIGS. 1 to 15, a working head 9 or a tool holder 6 of the hand tool 1 is connected via an adapter 10 with an actuator 11 in the form of a hydraulic actuator 12, which is integrated into the fuselage tool base 2 of the hand tool 1 (see also FIG. 2).

Part of the hydraulic actuator 12 can be an electric motor 33, which can be driven via the preferably provided accumulator 4. Upon actuation of a finger-actuated switch 14, for example arranged in the handle 5, hydraulic fluid (oil) is pumped out of a hydraulic tank 13 into a hydraulic space 15 via a pump, for example a piston pump, as a result of which a piston-like moving part 16 displaceably incorporated in the hydraulic space 15 is moved in the direction of a moving part or traversing part end position.

The moving part 16 can be exposed to the action of a return spring 17, which encompasses the moving part 16 in the area of a piston shaft section. The return spring 17 can sit in a chamber 18 defined by a chamber wall, which can be cylindrical, and here be supported with one end area on a chamber floor and with the opposite end on a piston section 19 of the moving part 16 that simultaneously extends into the chamber 18.

The piston section 19 can peripherally carry a radial gasket 20. The latter tightly seals the hydraulic space 15 created behind the moving part 16 in relation to the chamber 18 that guides the moving part 16 or in relation to a pneumatic space 62 that arises facing away from the hydraulic space 15.

As also shown, a working head 9 or a tool holder 6 can be interchangeably held on the cylindrical chamber wall defining the chamber 18. The working head 9 or tool holder 6 can be rotated around the geometric longitudinal axis x directed in the piston displacement direction in order to make convenient adaptations to local circumstances.

A tool carrier 21 connected with the moving part 16 can be linearly guided. The moving part can be more specifically a traversing part 60, see FIG. 7, in the working head 9. The traversing part 60 can also directly form the tool carrier 21.

The tool carrier 21 traversable in this way can hold a tool 22, which during the displacement via a traversing path a is moved in the direction toward a second tool 23. This second tool 23 is preferably fixed in place, here further preferably fixedly incorporated into the working head 9 or tool holder 6.

The tools 22, 23 can also be interchangeably incorporated in the working head 9 or tool holder 6.

For example, according to the embodiment of FIG. 1 to 6, the tools 22, 23 can be designed as pressing jaws 25 with pressing contours 24. FIGS. 7 to 14 show embodiments in which the tools 22 and 23 form blades 26 with cutting edges 27.

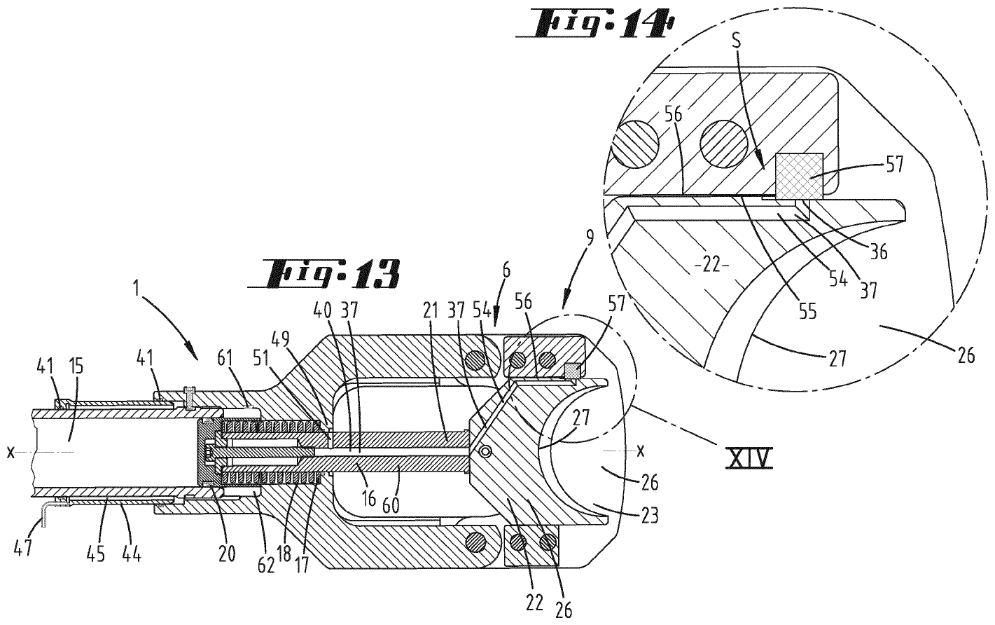

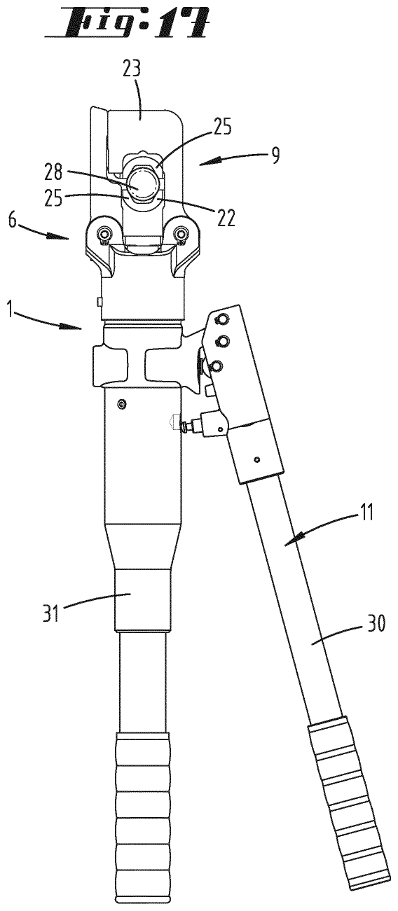

During the arrangement of the pressing jaws 25, the latter are moved toward each other until the pressing mouth 28 formed by pressing contours 24 is closed for compressing a pellet 50 (see FIG. 4). When blades 26 are used, the blades 26 are guided past each other in a completely overlapped position, so that an arising cutting mouth 29 is entirely closed in the traversing end position of the moving part 16 (see FIGS. 9 and 13).

By pumping hydraulic fluid into the hydraulic space 15, the moving part 16, and thereby the working head 9 or tool holder 6, is advanced against the return force of the spring 17.

The return movement of the moving part 16 preferably takes place solely due to the return force of the spring 17, wherein the hydraulic fluid flows out of the hydraulic space 15 and back into the hydraulic tank 13 via the moving part 16 while opening a return valve (not shown).

According to the embodiment of FIG. 16, the hydraulic tank 13 can be provided in an external actuator 7. In this case, the hydraulic tank 13 is connected with the hydraulic space 15 via a hydraulic hose 8.

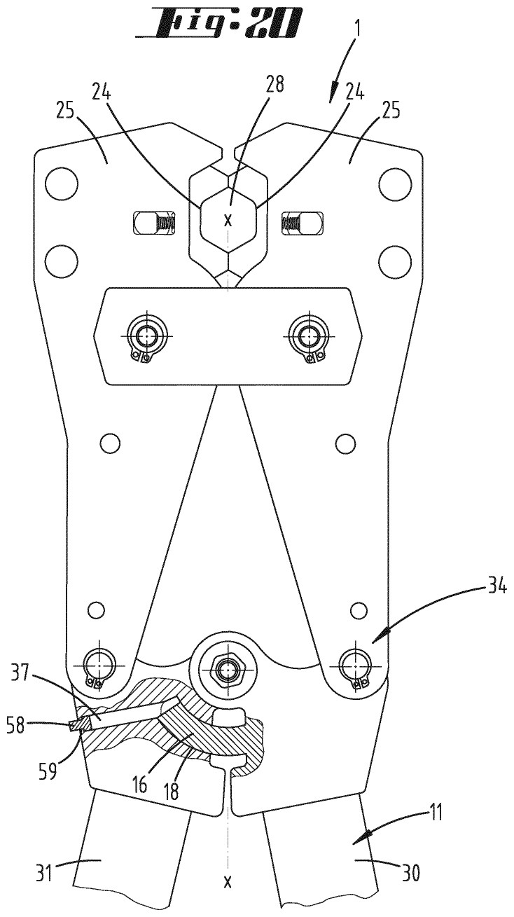

In the embodiment according to FIG. 17, an electric motor drive is not provided for conveying the hydraulic fluid. Rather, the actuator 11 is provided as a stem-type hand lever 30, which can be swiveled relative to a fixed hand lever 31 and the hydraulic actuator 12 fixed thereon.

A spindle drive 32 as shown in the embodiment of FIG. 18 can also be provided instead of a hydraulic actuator. Here as well, the drive works against the force of a return spring 17 incorporated into a chamber 18.

A spindle of the spindle drive 32 is driven via an electric motor 33 by actuating a switch.

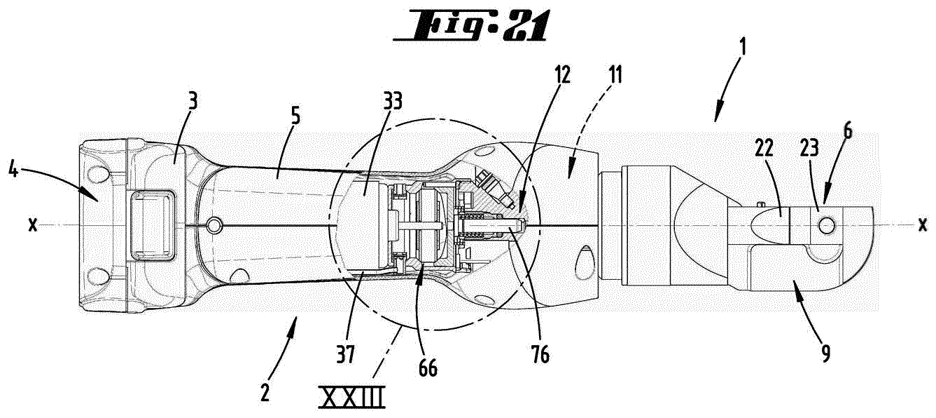

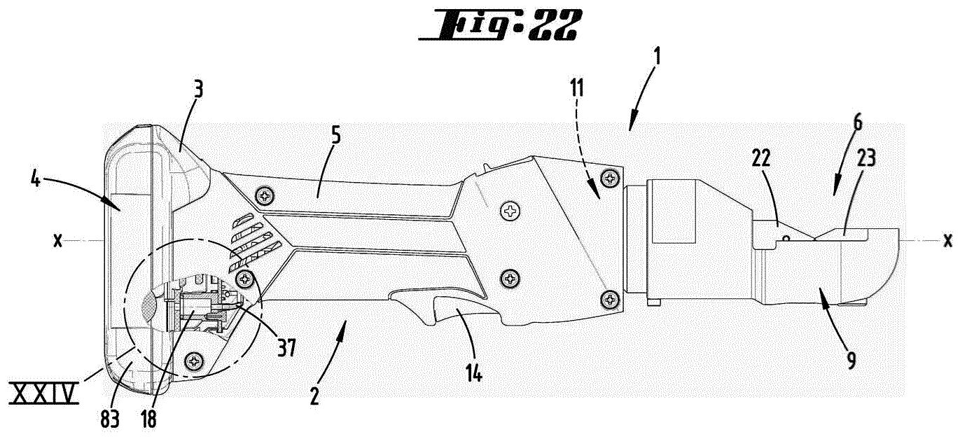

In addition, the hand tool 1 according to FIGS. 19 and 20 can also be a pincer-like tool to be operated strictly manually, for example for compressing a pellet, as shown.

A handgrip 30 that can be swiveled like a pincer toward another handgrip 31 here also serves as the actuator 11. A hinged formation 34 is here used to move two pressing jaws 25 toward each other while closing a pressing mouth 28.

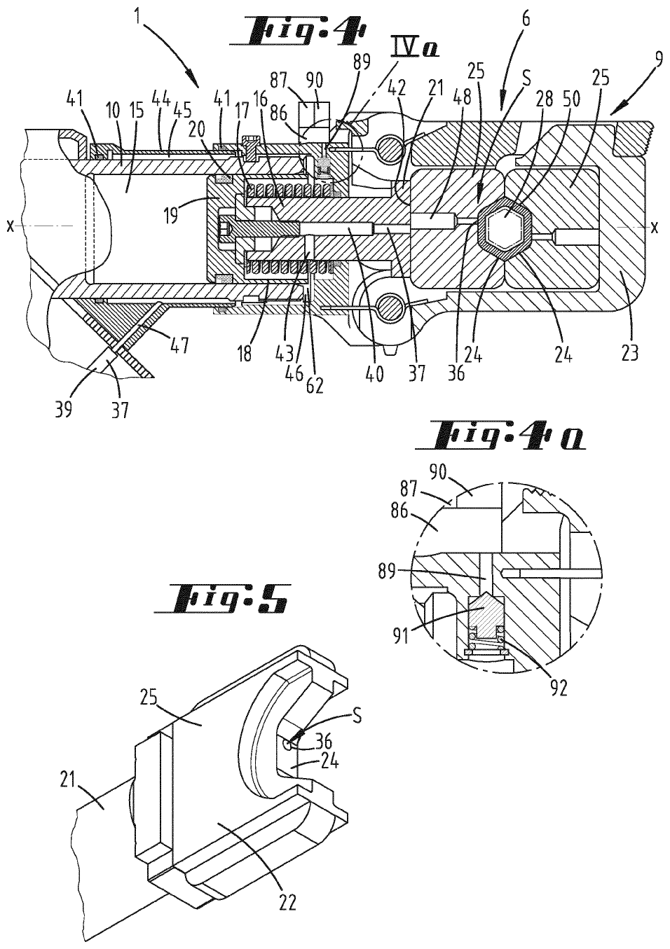

In particular in hydraulic hand tools, the pneumatic space 62, see FIG. 3, is provided by the chamber 18 on an air side of the piston-like moving part 16. During the operation of the hand tool 1 and the accompanying forward movement of the moving part 16 or the traversing part 60, the volume of the generally closed chamber 18 that forms a spring space is reduced in particular in the area of the pneumatic space 62, and air inside is compressed. Pneumatic sensors S of various kinds can be operated with this compressed air during the use and includes at least one pressure sensor 35, see FIG. 1. The pressure sensor 35 can be used to sense the air pressure inside of the chamber 18. The pressure sensor 50 can be directly arranged on the chamber 18, facing the interior of the chamber 186A potentially downstream electronic evaluation and/or control unit can trigger or prevent functions in the hand tool 1, depending on the measuring result.

Such a chamber 18 can also be used in a hand tool 1 having the spindle drive 32 according to FIG. 18 for a pressure measurement.

In a pincer-like hand tool 1 to be operated exclusively manually according to FIGS. 19 and 20, the generally closed chamber 18 can only arise during tool actuation, if necessary.

Change in the air pressure in the chamber can also be generated by changing the quantity of air, which means the volume of air, enclosed in the chamber. For example, the air pressure in the chamber can be changed without necessitating any moving of the moving part by connecting a pump or a compressor to the chamber.

With reference to FIG. 3, first is shown a possibility to have additionally or instead an higher air pressure generated by means of a pump or compressor, see reference No. 86. The pump or compressor may be actuated by a separate motor 87. The separate motor 87 can also have a separate battery 90. The air generated in the pump or compressor 86 can flow via a pump return valve 88 and separate air duct 89 into the chamber 18.

Further is shown with reference to FIG. 4a a possibility to have an independent operating part 91. The operating part 91 can be a piston, specifically an air piston. The piston can be biased into its starting position by a return spring 92. By this configuration, no additional air is delivered into the chamber 18 but rather the chamber 18 is only changed in its volume by moving the air piston. The air piston is a part of the wall of the chamber.

Beside this, further concerning the embodiment of FIG. 4a, there can be also an air pump or air compressor 86, a respective motor 87 and a separate air duct 89. Thereby, movement of the air piston is possible also by means of air pressure.

With respect to the evaluation and/or control unit mentioned earlier, this can be placed on a circuit board 38.

For example, the evaluation and/or control unit can be placed on a circuit board 38, as can a potentially provided memory for storing acquired air pressure data.

The various sensors S can be formed by sealable openings 36. These openings 36 are each connected with the pressure sensor 35 via airways 37, wherein the pressure sensor 35 can advantageously be arranged on the circuit board 38, for example one that also has a device controller. The circuit board 38 is preferably provided in the handle 5.

In a configuration of the hand tool 1 according to FIG. 16, the pressure sensor 35 arranged on the circuit board 38 can be provided in the separate actuator 7, for which purpose, aside from the hydraulic hose 8, a channel-like sensor line 64 can be formed between the pressure sensor 35 and the chamber 18 formed in the hand tool 1.

The airways 37 can be formed by airtightly connected hoses 39, which in particular extend inside of the tool housing. Additional airways 37 can be formed by open channels 40 in the working head 9 or the tool holder 6 and/or the tool 22, 23 and/or the moving part 16 and/or the adapter 10, wherein gaskets 41 can be interspersed to allow these channels 40 to also bridge interfaces between two sections that can potentially be moved, in particular rotated, relative to each other, for example between the working head 9 or the tool holder 6 and an adapter 10. Furthermore, these channels 40 can transition into hoses 39 inside of the tool housing.

Several channels 40 and/or hoses 39 for monitoring several sensors S can be connected with each other, so that only one airway 37 ultimately leads directly to the pressure sensor 35, as is preferred.

Initially described based upon FIGS. 1 to 6 is an exemplary embodiment in which the moving part 16, in the area of a piston shaft-like section, has an airway 37 running in the direction of the longitudinal axis x in the form of a preferably central airway channel 40, which faces away from the piston section 19 and opens into a front surface 42 of the moving part 16 or of the tool carrier 21.

A branch channel 43 oriented transverse to the preferably central airway channel 40 yields a connection to the interior of the chamber 18 or to the pneumatic space 62.

As shown in FIG. 4, the cylindrical wall forming the chamber 18 is enclosed by a collar 44, which is spaced radially apart from the cylindrical wall forming the chamber 18 to leave a tubular channel section 45 therebetween. This channel section 45 is sealed relative to the environment, and connected with the chamber 18, in particular the pneumatic space 62, via a transverse channel 46 formed in the chamber wall.

The channel section 45 can transition into a tube section 47, which in turn can be connected to one of the hoses 39 leading to the pressure sensor 35.

In an operational state of the hand tool 1, the central airway channel 40 extending through the moving part 16 passes over into a partial airway that extends in the held pressing jaw 25 up to the pressing contour 24 in the form of a channel section 48. The channel section 48 opens into one of the sealable openings 36 so as to form a pneumatic sensor S in the pressing contour 24, wherein the area having the opening 36 is only contacted by the jacket of a pellet 50 to be deformed once compression has been completely performed.

When the switch 14 is actuated (or if the hand tool 1 is designed with a swiveling handgrip 30 as shown of FIG. 17), the given and described drive advances the moving part 16 from the traversing start position exemplarily shown of FIG. 3 in the direction toward a traversing end position, so that the pellet 50 is increasingly deformed by the pressing contours 24 moving toward each other, ending in a complete deformation as shown in FIG. 4, in which the jacket of the pellet 50 seals the opening 36 provided in the pressing contour 24 of the moving pressing jaw 25.

The interior of the chamber 18 is connected via the transverse channel 46 with a transverse channel 52 to the pressure sensor 35, and via the branch channel 43 with the airway 37 leading to the opening 36, so that an elevated air pressure that arises in the chamber 18 also develops in the entire airway network with the opening 36 provided in the pressing contour 24 of the moving pressing jaw 25 closed.

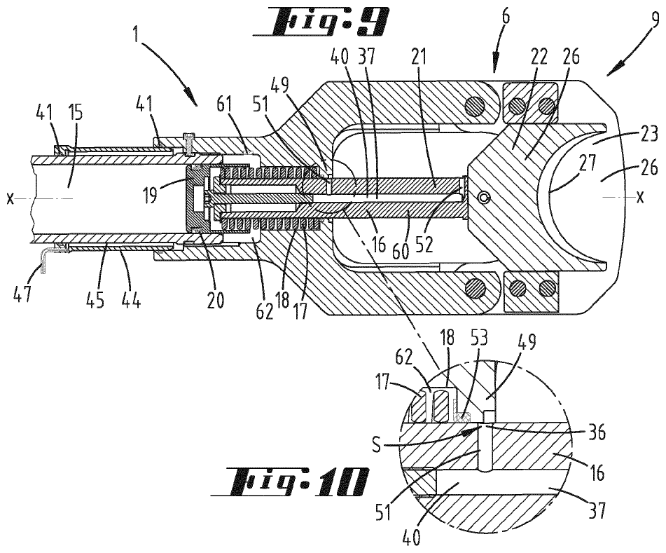

At the end of the compressing or crimping process, this results in a characteristic pressure peak, which points to a complete compression. The diagram D of FIG. 6 shows an exemplary pressure curve D1 of a compression process performed as intended with a pellet 50 that fits the pressing jaw 25 (for example, a 150 mm² cable lug).

The pressure peak DS of the pressure curve D1 can be easily acquired by the pressure sensor 35 and regarded as a signal for a correct compression.

By contrast, the pressure curve D2 arises when a pellet with too small of a cross-section is being compressed (further for example a 120 mm² cable lug). While being compressed, the undersized pellet does not reach a deformation that would cause the opening 36 provided in the pressing contour 24 of the moving pressing jaw 25 to become closed.

This yields a favorable compression or crimping test, the result of which can be imparted to the user, for example via an optical or acoustic signal. For example, the result can also be stored in a tool memory.

The air pressure that arises in the chamber 18 can also be used to acquire the traversing end position. FIGS. 7 to 15 show two exemplary embodiments relating thereto.

In the embodiment shown of FIGS. 7 to 10, the airway 37 is centrally formed in the moving part 16 along the longitudinal axis x. The central airway channel 40 has two transverse channels 51 and 52, which are radially oriented in relation to the longitudinal axis x, extending therefrom and which are spaced apart from each other in the direction of the longitudinal axis x.

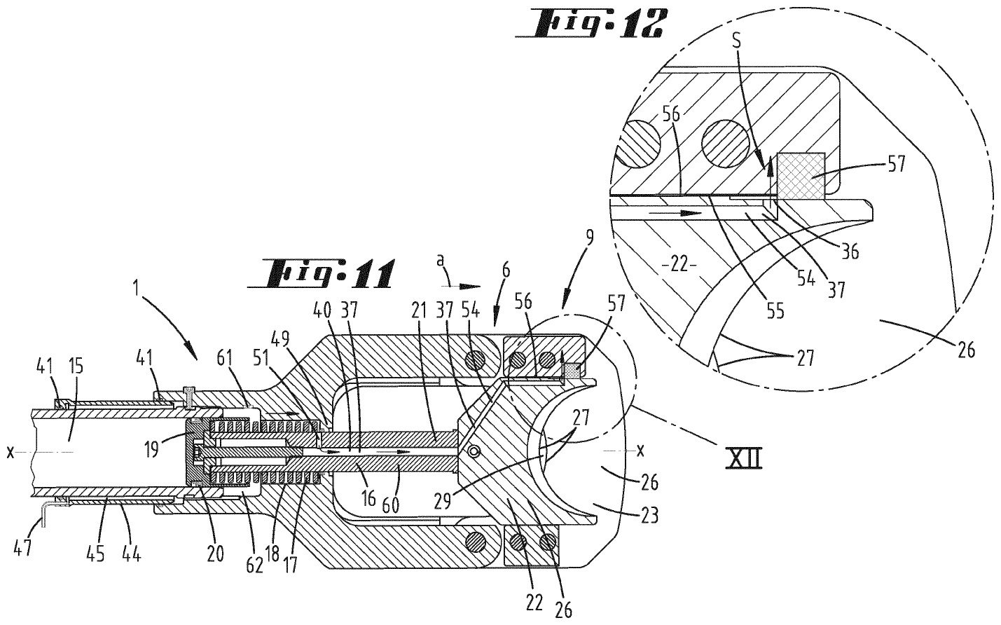

Transverse channel 52 which is shown proximate to the tool 22 (shown as blade 26) in the moving part 16 here opens freely into the environment, while the other transverse channel 51 opens into the chamber 18 or into the pneumatic space 62 with the opening 36, proceeding from the traversing start position up to a traversing position in which the traversing end position has not yet been reached (compare FIGS. 7 and 8).

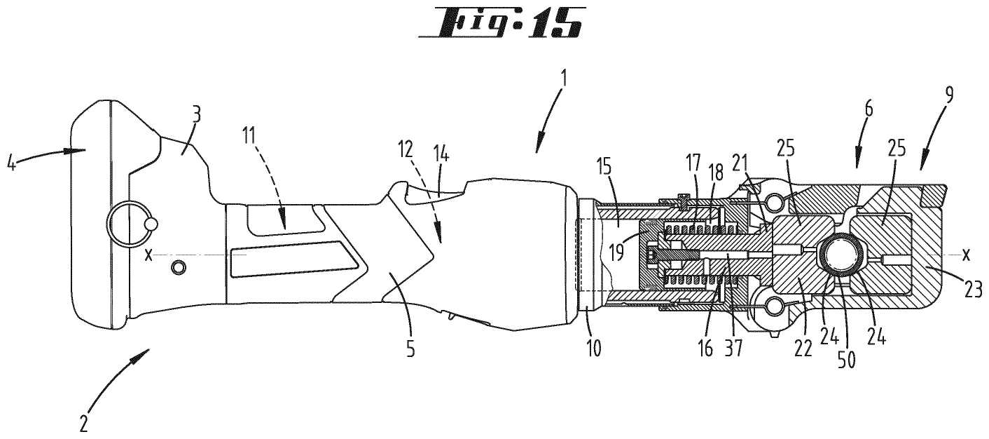

Upon reaching the traversing end position according to FIGS. 9 and 10, wherein the completely overlapped position is reached in this traversing end position given an arrangement of blades, the transverse channel 51 exits the chamber 18 or pneumatic space 62, and enters into a guide section 49 that surrounds the piston shaft-like section of the moving part 16.

This type of position detection, for example for a cutting tool, proves advantageous among other things in remote-controlled hand tools, since it is here very helpful to know when the cable has been cut or, during use in a hand tool for compressing a pellet, when compression has concluded.

The signal necessary for this purpose is given by the rise in air pressure, after one of the sealable openings 36 provided by transverse channel 51 by in the moving part 16 has passed a gasket 53, compare FIGS. 8 and 10, that outwardly seals the chamber 18 in the guide section 49, and preferably opens toward the ambient pressure. The gasket 53 may be an O-ring.

According to the exemplary embodiment of FIG. 11 to 14, the central airway channel 40 in the moving part 16 can on the one hand also open into a transverse channel 52 (not shown in FIGS. 11 to 14, but reference is made e.g. to FIG. 9), which always opens toward the interior of the chamber 18 or pneumatic space 62, independently of the traversing position. The central airway channel 40 allocated to the tool 22 (shown as a blade 26) transitions however preferably, and that is shown in FIGS. 11 to 14, into a connecting channel 54 that penetrates through the tool 22 and opens into one of the sealable openings 36 in the area of a guide surface 55 of the tool 22.

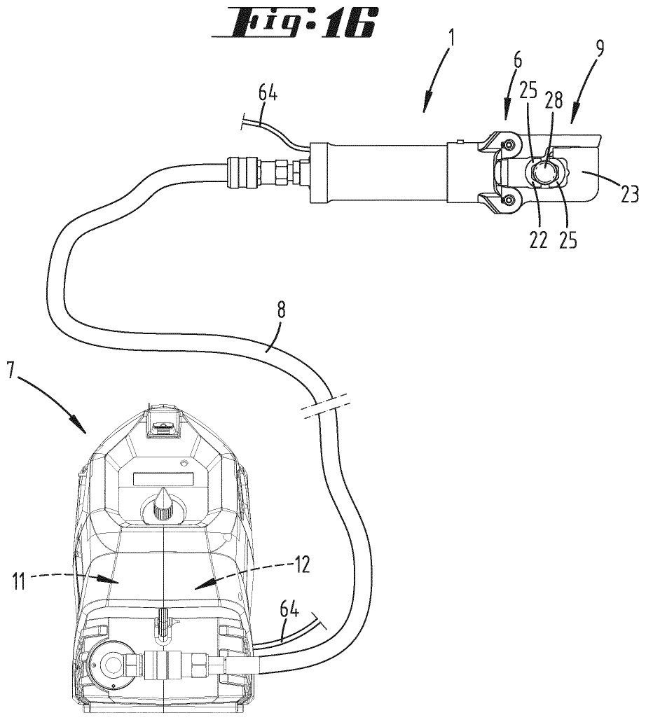

The guide surface 55 of the tool 22 interacts with a counter-guide surface 56 of the working head 9 or tool holder 6. The surfaces 55, 56 preferably about each other. As preferred, however, the opening 36 in the guide surface 55 can open into a recessed area of the guide surface 55, so that the opening 36 is initially freely directed toward the environment. The opening 36 in the guide surface 55 proceeds from the traversing start position up to a traversing position in which the traversing end position has not yet been reached, see FIGS. 11 and 12.

Upon reaching the traversing end position according to FIGS. 13 and 14, wherein the completely overlapped position is reached in this traversing end position given an arrangement of blades, the opening 36 in the guide surface 55 has traversed into an area of the working head 9 or tool holder 6 in which a sealing plug 57 in the counter-guide surface is provided, which seals the opening 36 in the guide surface 55.

Here as well, the signal is given by the rise in pressure, after the opening 36 in the guide surface 55 of the traversing part 60 has been covered and closed by the sealing plug 57. A characteristic rise in pressure indicates that the tool 1 has reached the traversing end position, and thus in the case of blades the overlapped position.

FIG. 18 shows an example with the spindle drive 32. The chamber 18 is connected via an airway 37, shown as a hose 39, with a sealable opening 36 that is formed in a pressing contour 24 of a pressing jaw 25. According to the first exemplary embodiment, this opening 36 is only closed once a pellet inserted as intended has reached the traversing end position, which leads to an evaluable, significant increase in air pressure.

In particular in the case of an electric motor and/or hydraulically or pneumatically driven hand tool 1, once the significant rise in pressure has been acquired, i.e., once the traversing end position thereby signaled has been reached, the advance can be immediately stopped and/or the return of the moving part 16 can be directly initiated.

The air pressure achievable in the chamber 18 and the airway system connected thereto is comparatively low, in any event so low as to be inadequate for the necessary force to develop in the area of the tools. The achievable air pressure also does not contribute to force development.

The pressure increase in the chamber 18 can also be regarded as a measure for the traversing path a of the traversing part 60.

Furthermore, a temperature sensor 61 can additionally be provided, which acquires the rise in temperature in the chamber 18 with an increasing compression of the air. If necessary, the acquired temperature value can be measured in addition to an acquired pressure value as a measure of the traversing path a between the traversing start position and the traversing end position.

In a pincer-like hand tool 1 according to FIGS. 19 and 20, the moving part 16 can be fixedly connected with a handgrip 30 that serves as the actuator 11. During the operation in which the handgrips 30 and 31 are moved toward each other like pincers, the moving part 16 dives into a chamber 18, which is formed in the area of the other handgrip 31.

As the handgrips 30 and 31 move toward each other, the pressing mouth 28 simultaneously closes and the moving part 16 dives into the chamber 18. This results in a continuous decrease of the volume in the chamber 18 and, as a result, a pressure increase arises in the chamber 18. This pressure increase moves a visual indicator 58 via an airway 37 extending from the chamber 18, which at a corresponding air pressure via a sealed opening 59 protrudes over the surrounding surface of the handgrip 31, and thereby shows the intended use.

As shown of FIGS. 21 to 24, the electric motor 33 is preferably arranged in the area of the handle 5 in a preferably rod-like embodiment of the hand tool 1, with the accumulator 4 further preferably being arranged in the area of the side of the electric motor 33 facing away from the working head 9 or tool holder 6. The accumulator 4, electric motor 33, hydraulic actuator 12 and working head 9 or tool holder 6 preferably are strung together along the longitudinal axis x of the tool 1.

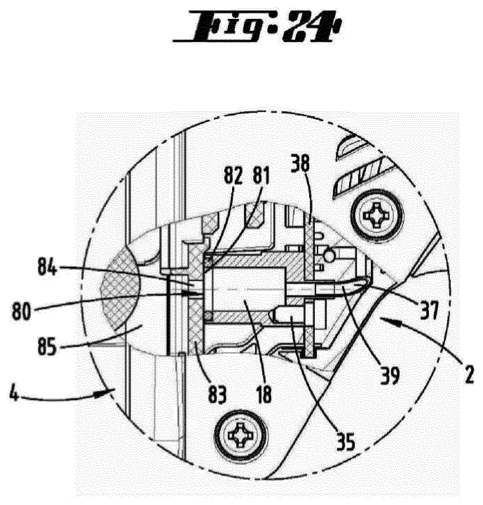

An output shaft 65, see FIG. 23, of the electric motor 33 is oriented along the longitudinal axis x, and, in order to form a friction gearbox 66, can carry a cage 67, in which two wheel-shaped output rotating bodies 68 are rotatably mounted. The geometric axes of rotation of the output rotating bodies 68 run parallel to each other and in the same direction as the longitudinal axis x.

The output rotating bodies 68 interact by way of tracks 69 and 70 formed by a chamfering of the peripheral edges with counter-tracks 71 and 72, which are formed in the area of two track bodies 73 and 74. The lower track body 73 facing the electric motor 33 is here provided non-rotatably and bound in the axial direction, while the upper track body 74 is designed so that it can be displaced in an axial direction while likewise being non-rotatably mounted.

The upper track body 74 is preloaded via a pressure spring 75 in an axial direction and in a direction toward the output rotating bodies 68, which are arranged between the track bodies 73 and 74 as viewed in an axial direction, so that a frictional connection is given between the output rotating bodies 68 and the track bodies 73 and 74.

The counter-tracks 70 and 71 of the track bodies 73 and 74 can form conical surfaces, wherein the selected counter-track 70 of the lower, fixed track body 73 can be circularly circumferential in relation to the longitudinal axis x of the tool 1. By contrast, the counter-running surface 71 of the axially movably held upper track body 74 deviates from a circumferential circle shape, so that an elliptical, wavy progression of the counter-track 71 can arise.

In operation, the friction gearbox 66 formed in this way correspondingly acts like a piston pump, which pumps hydraulic fluid into a hydraulic space via a pump piston 76 that can made to move axially, as described previously.

Reference is made to DE 101 24 265 A1 with respect to the other embodiments and operating principle of the friction gearbox 66. The contents of this patent application are hereby also fully incorporated into the disclosure of the present solution, including for the purpose of incorporating features of this patent application into claims of the present solution.

A pump area 77 provided in the friction gearbox 66 has an inlet valve 78 and an outlet valve 79, wherein the inlet valve 78 preferably allows an opening of the pump area 77 to the environment.

The outlet valve 79 can be connected to an airway 37 within the tool housing, for example in the form of a hose 39. The airway 37 can lead through the area of the handle 5 up to an interface 80 between the free end piece 3 of the tool housing and the accumulator 4 that is connected or to be connected.

The airway 37 can open into a chamber 18 allocated to the interface 80. The chamber 18 can have a housing-side chamber opening 81 in the area of the interface 80 and generally opposite the airway mouth. A geometric centerline of this chamber opening 81 can generally run parallel to the longitudinal axis x (see FIG. 24).

A pressure sensor 35 can protrude into the chamber 18, e.g., positioned where the airway 37 opens into the chamber 18, wherein the pressure sensor 35 can also be arranged on a circuit board 38 in this exemplary embodiment.

With the accumulator 4 arranged as intended, the chamber opening 81, which is here sealed by a circumferential ring gasket 82, presses against a facing housing wall 83 of the accumulator 4, wherein an opening 84 provided in the housing wall 83 enables a sealed connection of the airway 37 to a housing interior 85 of the accumulator 4 via the chamber 18. Due to the connection established via the openings 81 and 84, the housing interior 85 can provide for a spatial expansion of the chamber 18 to be monitored with respect to the air pressure.

As a result of the configuration described above, the friction gearbox 66 that acts like an air piston pump during operation in conjunction with the inlet valve 78 and the outlet valve 79 makes it possible to monitor the state of the accumulator housing wall 83, for example. As opposed to the exemplary embodiments described above, an air pressure that can be drawn upon for evaluation purposes is achieved in an area in front of the hydraulic actuator 12 as viewed in the operating direction of the moving part 16, while correspondingly circumventing the working head 9 or tool holder 6 in particular.

In addition, the principle of the air piston pump also makes it possible deliver a larger air quantity into the chamber 18, here via the airway 37, by comparison to the air pressure buildup in the area of the moving part 16.

For example, as the result of dropping the hand tool 1 connected to an accumulator 4, or further even of just dropping the accumulator 4 itself, a crack in the accumulator housing wall 83 can result. The described solution enables the detection of this type of damage (crack) in the accumulator housing wall 83, wherein the overall damage can be regarded as an indicator of damage to the accumulator 4 as a whole.

If an air pressure that can be acquired by the pressure sensor 35 builds up in the chamber 18 to at least a predefined level during use as intended after starting up the motor, this makes it possible to conclude that the accumulator housing wall 83 is intact and correspondingly crack-free. The chamber 18 also given by the housing interior 85 is closed on all sides, and connected tightly to the device-side chamber opening 81.

By contrast, if the pressure buildup in the chamber 18 is absent or not high enough, this is regarded as a disturbance in the area of the accumulator 4, in particular its housing wall 85, via the pressure sensor 35 and via an evaluation unit, for example arranged on the circuit board 38. Optical or acoustic signaling can indicate to the user that the connected accumulator 4 may have a defect, for example in the form of a crack. In this way, it can also be indicated when the accumulator 4 has been improperly connected, for example by leaving a gap opening that arises toward the environment in the area of the interface 80.

In order to prevent the generated air pressure from exceeding a predefined maximum with an undamaged accumulator 4 connected as intended, a relief valve can be provided in the area of the airway 37 or allocated to the chamber 18, for example.

Reference List

| | |
|---|---|
| 1 | Hand tool |
| 2 | Fuselage tool base |
| 3 | End piece |
| 4 | Accumulator |
| 5 | Handle |
| 6 | Tool holder |
| 7 | Actuator |
| 8 | Hydraulic hose |
| 9 | Working head |
| 10 | Adapter |
| 11 | Actuator |
| 12 | Hydraulic actuator |
| 13 | Hydraulic tank |
| 14 | Switch |
| 15 | Hydraulic space |
| 16 | Moving part |
| 17 | Return spring |
| 18 | Chamber |
| 19 | Piston section |
| 20 | Radial seal |
| 21 | Tool carrier |
| 22 | Tool |
| 23 | Tool |
| 24 | Pressing contour |
| 25 | Pressing jaw |
| 26 | Blade |
| 27 | Cutting edge |
| 28 | Pressing mouth |
| 29 | Cutting mouth |
| 30 | Handgrip |
| 31 | Handgrip |
| 32 | Spindle drive |
| 33 | Electric motor |
| 34 | Hinged formation |
| 35 | Pressure sensor |
| 36 | Opening |
| 37 | Airway |
| 38 | Circuit board |
| 39 | Hose |
| 40 | Channel |
| 41 | Gasket |
| 42 | Front surface |
| 43 | Branch channel |
| 44 | Collar |
| 45 | Channel section |
| 46 | Transverse channel |
| 47 | Tube section |
| 48 | Channel section |
| 49 | Guide section |
| 50 | Pellet |
| 51 | Transverse channel |
| 52 | Transverse channel |
| 53 | Gasket |
| 54 | Connecting channel |
| 55 | Guide surface |
| 56 | Counter-guide surface |
| 57 | Sealing plug |
| 58 | Indicator |
| 59 | Opening |
| 60 | Traversing part |
| 61 | Temperature sensor |
| 62 | Pneumatic space |
| 64 | Sensor line |
| 65 | Output shaft |
| 66 | Friction drive |
| 67 | Cage |
| 68 | Output rotating body |
| 69 | Track |
| 70 | Track |
| 71 | Counter-track |
| 72 | Counter-track |
| 73 | Lower track body |
| 74 | Upper track body |
| 75 | Pressure spring |
| 76 | Pump piston |
| 77 | Pump area |
| 78 | Inlet valve |
| 79 | Outlet valve |
| 80 | Interface |
| 81 | Chamber opening |
| 82 | Ring gasket |
| 83 | Accumulator housing wall |
| 84 | Opening |
| 85 | Housing interior |
| 86 | Pump/ Compressor |
| 87 | Motor |
| 88 | Return valve |
| 89 | Air duct |
| 90 | Battery |
| 91 | Operating part |
| 92 | Return spring |
| a | Traversing path |
| s | Longitudinal axis |
| D | Diagram |
| D1 | Pressure curve |
| D2 | Pressure curve |
| DS | Pressure peak |
| S | Sensor |

1. A hand tool comprising:
a chamber in which an air volume with an air pressure is configured to be enclosed;
an actuator;
a moving part; and,
an opening part independent of the moving part,
wherein the actuator drives the moving part directly or via a gearbox or by a hydraulic medium configured to perform an intended operation,
wherein the moving part or the opening part are configured to change the air pressure by changing a space of the chamber or by delivering additional air into the chamber,
wherein the air pressure is evaluated for identifying a state of the hand tool, and
wherein the driving of the moving part is configured to be performed with or without making use of the pressure.

2. The hand tool according to claim 1, further comprising a pressure sensor configured to measure the air pressure in the chamber, and a measured air pressure is evaluated for detecting the state of the hand tool.

3. The hand tool according to claim 1, wherein the space of the chamber is changed by moving a wall or a part of the wall of the chamber.

4. The hand tool according to claim 1, wherein a change in the air pressure is generated by delivering additional air into the chamber and/or is coupled to the operation.

5. (canceled)

6. A hand tool comprising:
a chamber in which an air volume with an air pressure is configured to be enclosed;
an actuator;
a moving part; and
wherein the actuator drives the moving part directly or via a gearbox or by a hydraulic medium configured to perform an intended operation,
wherein the air pressure is changed, and is evaluated for acquiring a state of the hand tool, and
wherein the operation is performed independently of the air pressure that arises in the chamber.

7. The hand tool according to claim 6, further comprising a pressure sensor configured to measure the air pressure in the chamber, and a measured air pressure is evaluated for acquiring the state of the hand tool.

8. The hand tool according to claim 6, wherein a change in the air pressure is generated by changing a size of the chamber and/or by changing a quantity in terms of a volume of air enclosed in the chamber and/or arises when the operation is triggered or performed.

9.-10. (canceled)

11. The hand tool according to claim 6, wherein the chamber has a sealable opening.

12. The hand tool according to claim 11, wherein the opening is connected with the chamber via an airway.

13. The hand tool according claim 6, wherein the moving part is a traversing part, which is traversed from a traversing start position into a traversing end position.

14. The hand tool according to claim 13, wherein a traversal of the traversing part into the traversing end position is accompanied by a reduction of the volume of the chamber.

15. The hand tool according to claim 6, wherein the increase in air pressure is associated with an increase in a temperature of the air volume in the chamber and/or wherein the air pressure increase provides a measure for a traversing path.

16. The hand tool according to claim 15, wherein a temperature sensor is provided for measuring the increase in temperature.

17. (canceled)

18. The hand tool according to claim 15, wherein the air pressure increase and the increase in temperature is regarded as a measure for the traversing path.

19. The hand tool according to claim 11, wherein the opening is sealed by traversing the traversing part into the traversing end position.

20. The hand tool according to claim 13, wherein the traversal of the traversing part into the traversing end position makes it possible to raise the air pressure and/or wherein the increase in air pressure in the chamber can be regarded as is the traveling end position of the traversing part having been reached.

21-22. (canceled)

23. The hand tool according to claim 22, further comprising a working head having a tool with a pressing contour, wherein the pressing contour has an opening.

24. The hand tool according to claim 6, wherein the pressure increase is a completed compression of a pellet.

25. The hand tool according to claim 6, further comprising a connected accumulator, and that a pressure increase in the chamber is the presence of a properly connected accumulator undamaged on the housing side.

26. The hand tool according to claim 25, wherein a movement of the gearbox is configured to increase the pressure in the chamber.
